(19) United States
(12) Patent Application Publication
(10) Pub. No.: US 2009/0092430 A1
(43) Pub. Date: Apr. 9, 2009

(54) SHEET CARRYING UNIT AND SHEET COOLING DEVICE USING THE SAME, AND IMAGE FORMING APPARATUS

(75) Inventors: Satoru Nishikawa, Ebina-shi (JP); Naochika Iida, Ebina-shi (JP); Shiro Miyake, Ebina-shi (JP); Takaharu Koyama, Ebina-shi (JP); Masayuki Enta, Ebina-shi (JP); Masayuki Yamamiya, Ebina-shi (JP); Shuuichi Yamamura, Ebina-shi (JP); Yoshihiko Ichikawa, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/143,477

(22) Filed: Jun. 20, 2008

(30) Foreign Application Priority Data
Oct. 3, 2007 (JP) 2007-259748

(51) Int. Cl. G03G 15/00

(52) U.S. Cl. 399/390

(57) ABSTRACT

A sheet carrying unit, includes: a first belt stretched by a plurality of rollers, the first belt carrying a sheet while putting the sheet on a surface of the first belt; a first driving roller that drives the first belt; a second belt stretched by a plurality of rollers, the second belt carrying the sheet while holding the sheet together with the first belt; and a second driving roller that drives the second belt; wherein a frictional force generated between the second driving roller and the second belt is set smaller than a frictional force generated between the first belt and the first driving roller, a frictional force generated between the first belt and the sheet, and a frictional force generated between the second belt and the sheet, respectively.

### CROSS-REFERENCE TO RELATED APPLICATION

This application is based on and claims priority under 35 USC 119 from Japanese Patent Application Nos. 2007-259748 filed Oct. 3, 2007.

### BACKGROUND

### Technical Field

The present invention relates to a sheet carrying unit and a sheet cooling device using the same, and an image forming apparatus.

### SUMMARY

According to an aspect of the invention, there is provided a sheet carrying unit, including: a first belt stretched by a plurality of rollers, the first belt carrying a sheet while putting the sheet on a surface of the first belt; a first driving roller that drives the first belt; a second belt stretched by a plurality of rollers, the second belt carrying the sheet while holding the sheet together with the first belt; and a second driving roller that drives the second belt; wherein a frictional force generated between the second driving roller and the second belt is set smaller than a frictional force generated between the first belt and the first driving roller, a frictional force generated between the first belt and the sheet, and a frictional force generated between the second belt and the sheet, respectively.

### BRIEF DESCRIPTION OF THE DRAWINGS

Exemplary embodiments of the present invention will be described in detail based on the following figures, wherein:

FIG. 1 is a configurative view showing a recording material carrying unit according to an exemplary Embodiment 1 of the present invention;

FIG. 2 is a configurative view showing a tandem full color printer to which a recording material carrying unit and a recording material cooling device according to exemplary Embodiment 2 of the present invention are applied;

FIG. 3 is a configurative view showing a pertinent portion of the recording material cooling device to which the recording material carrying unit according to exemplary Embodiment 2 of the present invention is applied;

FIG. 4 is a configurative view showing the recording material cooling device to which the recording material carrying unit according to exemplary Embodiment 2 of the present invention is applied;

FIGS. 5A and 5B are configurative views showing a driving roller respectively;

FIG. 6 is a configurative view showing a driving force and a load applied to the recording material cooling device to which the recording material carrying unit according to exemplary Embodiment 2 of the present invention is applied;

FIG. 7 is a schematic view showing a press-contact state of a first carrying belt and a second carrying belt;

FIG. 8 is a schematic view showing another press-contact state of the first carrying belt and the second carrying belt;

FIG. 9 is a schematic view showing still another press-contact state of the first carrying belt and the second carrying belt;

FIG. 10 is a schematic view showing yet still another press-contact state of the first carrying belt and the second carrying belt;

FIG. 11 is a configurative view showing the recording material cooling device to which the recording material carrying unit according to exemplary Embodiment 2 of the present invention is applied;

FIG. 12 is a graph showing a relationship between a load and a slip ratio when a coating is applied to a driving roller;

FIG. 13 is a graph showing a relationship between a load and a slip ratio when the coating is not applied to the driving roller;

FIG. 14 is a configurative view showing a recording material cooling device to which a recording material carrying unit according to exemplary Embodiment 3 of the present invention is applied;

FIG. 15 is a configurative view showing a recording material cooling device to which a recording material carrying unit according to exemplary Embodiment 4 of the present invention is applied; and

FIG. 16 is a configurative view showing a recording material cooling device to which a recording material carrying unit according to exemplary Embodiment 5 of the present invention is applied.

### DETAILED DESCRIPTION

Exemplary embodiments of the present invention will be explained with reference to the drawings hereinafter.

### Embodiment 1

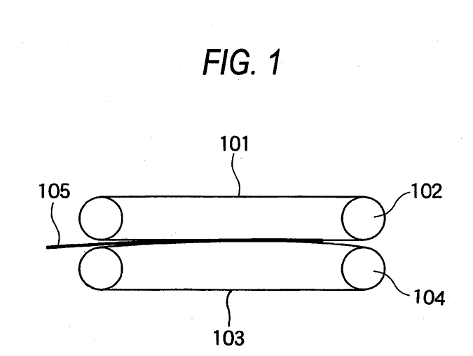

FIG. 1 shows a recording material carrying unit according to Embodiment 1 of the present invention. When a first driving roller 102 is rotated while contacting a first belt 101, a driving force is transmitted to this first belt 101 to rotate it. Also, a second belt 103 is driven similarly by a second driving roller 104. Also, a recording material 105 is carried by the first belt 101 and the second belt 103 while being put between them.

Here, it is assumed that a velocity of the belt 101 is V1, a velocity of the driving roller 102 is V2, a velocity of the belt 103 is V3, a velocity of the driving roller 104 is V4, and a velocity of the recording material 105 is V5. Such a condition is ideal that a value of V1 becomes equal to a value of V3 and V1=V2=V3=V4=V5 is obtained, but sometimes all velocities are not always equal mutually on account of an error of the component, an influence of the recording material 105, and the like. Therefore, a velocity difference (V1−V2) is set larger than velocity differences between the recording material and the first and second belts, i.e., (V5−V1) and (V5−V3). In this case, a velocity difference (V3−V4) may be set larger than (V5−V1) and (VS−V3) instead of (V1−V2).

Also, in this exemplary embodiment, a friction force may be defined. More particularly, a friction force between the belt 101 and the driving roller 102 may be set smaller than a friction force between the belt 101 and the recording material 105 and a friction force between the belt 102 and the recording material 105. When constructed in this manner, a slip between the belt 101 and the driving roller 102 is ready to occur, and thus a slip between the recording material 105 and the belt 101 is suppressed in contrast to the case where a friction force between the belt 101 and the recording material 105 and a friction force between the belt 103 and the recording material 105 are set smaller than a friction force between the belt 101 and the driving roller 102. In this case, the belt 101 and the driving roller 102 may be replaced with the belt 103 and the driving roller 104.

Also, it would be better to increase a velocity difference between the belt member that contacts a back surface of the recording material 105 of which front surface should be less damaged, and its driving roller. For example, it would be much better to increase a velocity difference between the belt member that contacts a back surface of the recording material 105 of which front surface is a recording surface, and its driving roller. Also, when a paper that bears an image on both surfaces is employed as the recording material 105, it would be better to increase a velocity difference between the belt member that contacts a back surface of the recording material 105 of which front surface is relatively easily damaged, e.g., a surface on which a fused state is proceeding much more, and the driving roller for driving this member. Also, as another example, when a card on one surface of which an electronic medium is mounted and characters are printed and on the other surface of which only characters are printed is carried as the recording material 105, it would be better to increase a velocity difference between the belt member, which is contacting the surface on which only the characters are printed, and the driving roller for driving this card. Here, the card and the paper are listed as the recording material 105 by way of example, but other substances may be employed.

### Embodiment 2

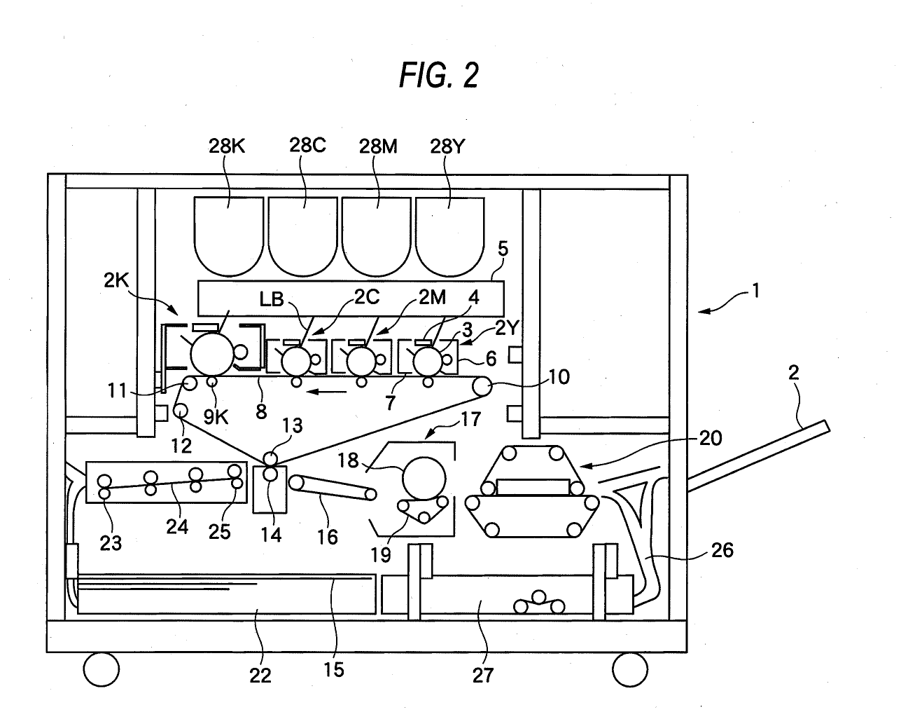

FIG. 2 shows a tandem-system full color printer as an image forming apparatus to which a recording material carrying unit and a recording material cooling device according to Embodiment 2 of the present invention are applied. This full color printer is a high-speed machine having a high productivity such that the number of full-color printed sheet per unit time is large such as about 40 to 50 sheets/minute. The full color printer outputs the image based on image data fed from a personal computer (not shown), or the like. In this case, the tandem-system full color printer is not equipped with an image reading device. But it is of course that a full color copier or facsimile equipped with an image reading device, a composite machine having these functions, or the like may be constructed. Also, it is of course that either other system may be utilized in place of the tandem system or an ink jet, and the like may be utilized.

In FIG. 2, 1 denotes a main body of the tandem-system full color printer. Four image forming portions 2Y, 2M, 2C, 2K in yellow (Y), magenta (M), cyan (C), and black (K) are aligned at a predetermined interval in the horizontal direction in an interior of the full-color printer main body 1.

These four image forming portions 2Y, 2M, 2C, 2K are constructed basically similarly. Each of these image forming portions is constructed roughly by a photosensitive drum 3 as an image bearing body that is rotated at a predetermined rotation velocity, a primary charging scorotron 4 as a charging unit that charges uniformly a surface of the photosensitive drum 3, an image exposure unit 5 for forming an electrostatic latent image by exposing an image based on color image data corresponding to the surface of the photosensitive drum 3, a developing unit 6 for developing the electrostatic latent image formed on the photosensitive drum 3 by a toner in a corresponding color, and a cleaning unit 7 for cleaning a toner remaining on the photosensitive drum 3, and the like.

In this case, a diameter of the photosensitive drum 3K of the black image forming portion 2K is set larger than diameters of the photosensitive drums 3Y, 3M, 3C. Also, the image exposure unit 5 is constructed in common to four image forming portions 2Y, 2M, 2C, 2K. It is of course that this image exposure unit 5 may be provided individually to respective image forming portions 2Y, 2M, 2C, 2K.

The color image data corresponding to the image exposure units 5Y, 5M, 5C, 5K are output sequentially from the image processing system (not shown) to the image forming portions 2Y, 2M, 2C, 2K in respective colors of yellow (Y), magenta (M), cyan (C), and black (K). A laser beam LB that is emergent from the image exposure units 5Y, 5M, 5C, 5K in response to the image data is exposed/scanned on surfaces of the photosensitive drums 3Y, 3M, 3C, 3K respectively, and the electrostatic latent image is formed. The electrostatic latent images formed on the photosensitive drums 3Y, 3M, 3C, 3K are developed as the visual toner images in colors of yellow (Y), magenta (M), cyan (C), and black (K) by the developing units 6Y, 6M, 6C, 6K respectively.

The toner images in colors of yellow (Y), magenta (M), cyan (C), and black (K) being formed sequentially on the photosensitive drums 3Y, 3M, 3C, 3K of the image forming portions 2Y, 2M, 2C, 2K are transferred in multiple colors onto an endless belt-like intermediate transfer belt 8 arranged under the image forming portions 2Y, 2M, 2C, 2K by primary transferring rollers 9Y, 9M, 9C, 9K. This intermediate transfer belt 8 is stretched on a plurality of rollers consisting of a driving roller 10, a stretching force roller 11, a steering roller 12, a backup roller 13, and the like by a predetermined streching force. The intermediate transfer belt 8 is driven by the driving roller 10, which is rotated/driven by a dedicated driving motor (not shown) that is excellent in a constant speed characteristic, to circulate/move along an arrow direction at a predetermined velocity. As the intermediate transfer belt 8, for example, an endless belt that is formed by forming a flexible stripe-like synthetic resin film made of PET, polyimide, or the like and then connecting both ends of the stripe-like synthetic resin film by the methods such as the deposition, or the like may be employed. In this case, this endless belt may be formed in a seamed or seamless manner.

The toner images in respective colors of yellow (Y), magenta (M), cyan (C), and black (K) being transferred in multiple colors onto the intermediate transfer belt 8 are secondarily transferred onto a recording paper 15 as the recording material by a secondary transferring roller 14, which is brought into contact with the backup roller 13 by a pressure, in terms of a press-fitting force and an electrostatic force. The recording paper 15 onto which the toner images in respective colors are transferred is carried to a fixing unit 17 by a carrying belt 16. Then, the recording paper 15 onto which the toner images in respective colors are transferred is subject to a fixing process by a heating roller 18 and a fixing belt 19 of the fixing unit 17, then is cooled by a recording material cooling device 20, and then is exhausted on a paper receiving tray 21 that is provided on the outside of the printer main body 1. Here, the toner images that are passed through the fixing unit 17 and are fixed on the recording paper 15 are introduced into the recording material cooling device 20 in a fused state or a state close to the fused state.

As shown in FIG. 2, the recording paper 15 having predetermined size and material is fed from a paper feed tray 22, which is provided on the bottom portion of the printer main body 1, by a paper feeding roller (not shown), and then is carried once to a register roller 25 via a paper carrying path 24 having a plurality of carrying rollers 23 and stopped there. The recording paper 15 fed from the paper feed tray 22 is sent out to a secondary transferring portion of the intermediate transfer belt 8 by the register roller 25 that is rotated/driven at a predetermined timing. In this case, the recording paper 15 is not limited to the recording paper as an ordinary paper, and the recording paper 15 contains all recording materials such as a thick paper such as a coated paper, or the like, an OHP sheet, and the like.

Also, when an image is formed on both surfaces of the recording paper 15, the recording paper 15 on one surface of which the image is formed is not exhausted on the paper receiving tray 21 as it is, but is cooled by the recording material cooling device 20 and then contained once in a paper turning tray 27 by switching a carrying path of the recording paper 15 to a double-sided copy carrying path 26 on the bottom side. Then, the recording paper 15 contained in this paper turning tray 27 is carried to the register roller 25 via a paper carrying path (not shown) provided on the paper feed tray 22 and the ordinary paper carrying path 24 in a state that the recording paper 15 is placed face down by the paper turning tray 27. Then, another image is formed on the back surface of the recording paper 15, and then the recording paper 15 is exhausted onto the paper receiving tray 21 via the fixing unit 17 and the recording material cooling device 20.

In FIG. 2, references 28Y, 28C, 28M, 28K denote toner cartridges that are provides on the upper area of the printer main body 1 and contain toners in respective colors of yellow (Y), magenta (M), cyan (C), and black (K) respectively.

By the way, a recording material carrying unit according to this embodiment, includes a pair of endless belt members driven by a driving roller respectively to circulate/move, for holding and carrying a recording material mutually in a part of a moving path; wherein a velocity deference between either of the pair of endless belt members and the driving roller for driving the concerned endless belt member is set in an absolute value larger than velocity differences between the recording material and respective endless belt members.

Also, in this exemplary embodiment, a pair of belt members driven by a driving roller respectively to circulate/move, for holding and carrying a recording material mutually in a part of a moving path are provided, and a slip is caused between an endless belt, whose moving velocity is relatively high, out of a pair of belt members between which a velocity difference is generated, and the driving roller for driving the concerned endless belt, whereby the velocity difference is absorbed.

Also, a recording material cooling device according to this exemplary embodiment, includes a first belt-like member that contacts an image surface side of a recording material, on which an image is formed, to carry the recording material; a first driving roller for driving the first belt-like member to circulate/move; a second belt-like member for holding and carrying the recording material together with the first belt-like member in a part of a moving path of the first belt-like member; a second driving roller for driving the second belt-like member to circulate/move; and a cooling unit that contacts an inner peripheral surface within an interval, in which the recording material is carried, out of the moving path of the first belt-like member to cool the first belt-like member; wherein a frictional force generated between the second belt-like member and the second driving roller is set smaller than a frictional force generated between the first belt-like member and the first driving roller, a frictional force generated between the recording material and the first belt-like member, and a frictional force generated between the recording material and the second belt-like member.

Here, the first belt-like member contacts the image surface side of the recording material on which the image is formed. But the material on both surfaces of which the image is formed maybe carried as the recording material, and the image surface may also contact the second belt-like member. In this case, when the image surface side, whose temperature is relatively high, of both surfaces is brought into contact with the first belt-like member, a cooling efficiency can be improved. This is because the cooling unit cools the inner peripheral surface of the first belt-like member.

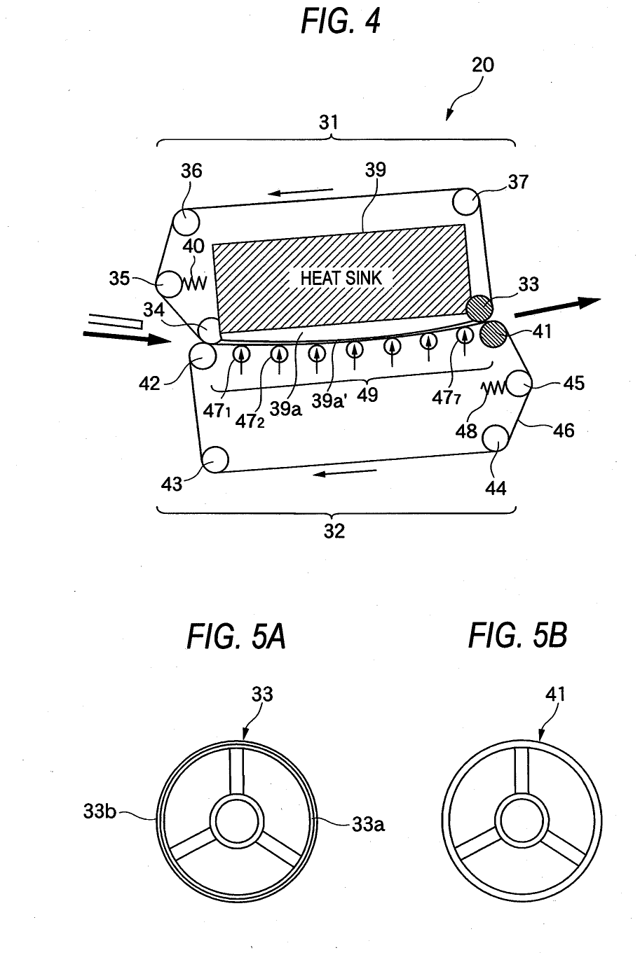

FIG. 4 is a configurative view showing the recording material cooling device to which the recording material carrying unit according to Embodiment 2 of the present invention is applied.

As shown in FIG. 4, the recording material cooling device 20 is constructed roughly by an upper belt unit 31 and a lower belt unit 32. The upper belt unit 31 has a plurality of stretching rollers 33 to 37 containing a first driving roller, a first carrying belt 38 as an endless belt member that is stretched by a predetermined stretching force (tensile force) between these stretching rollers 33 to 37, and a heat sink 39 as a cooling unit arranged on the inside of the first carrying belt 38 to cool the first carrying belt 38.

These stretching rollers 33 to 37 are basically constructed similarly mutually. Each of these stretching rollers 33 to 37 is made of a metal such as aluminum, stainless steel, or the like, a rigid synthetic resin, or the like, and is formed as a round column shape or circular cylinder shape whose outer diameter is about 28 to 30 mm, for example. Also, surfaces of these stretching rollers 33 to 37 are finished to have a predetermined surface roughness as the case may be. As shown in FIGS. 5A and 5B, for example, the first driving roller 33 as the above first driving roller is constructed by coating a coating layer 33b, which is made of a material such as polyurethane, cellular silicon rubber, or the like having a large coefficient of friction, on a surface of a stainless roller 33a to have a predetermined thickness of about 0.5 mm. An outer diameter of the first driving roller 33 containing the coating layer 33b is set to have the same value as other stretching rollers 34 to 37. The first driving roller 33 is arranged adjacent to the downstream side of the heat sink 39 along the moving direction of the first carrying belt 38 such that a driving force can be applied directly to the first carrying belt 38 that is passing by the heat sink 39. Also, the first driving roller 33 is rotated/driven at a predetermined velocity (e.g., a peripheral velocity of 150 to 200 mm/sec) by a driving source (not shown)

Also, the first carrying belt 38 is stretched like a substantially flat plane between the first driving roller 33 and the first stretching roller 34 that is arranged adjacent to the upstream side along the belt moving direction of the first driving roller 33 via the heat sink 39. Also, a belt surface of the first carrying belt 38 is contacting a belt surface of a second carrying belt 46 between the first driving roller 33 and the first stretching roller 34 mutually. The toner image in the fused state of the recording material or close to the fused state is cooled on this substantially flat plane and is not in the fused state.

In such a condition that remaining configurations are identical, when a carrying velocity of the recording material is fast, normally a contact time to the cooling portion is prolonged by using the wider cooling portion rather than a contact time given by the narrower cooling portion, and thus a temperature of the recording material is lowered. Also, when a carrying velocity of the recording material is slow, a temperature of the recording material is lowered during the carrying operation and the toner image is not in the fused state. However, when a carrying velocity of the recording material is fast and also the recording material bearing the toner image that is in its fused state yet thereon is exhausted by the exhausting portion and stacked mutually on the paper receiving tray, sometimes such a situation happens that the toner image sticks to other stacked papers. In this manner, in such a condition that remaining configurations are identical, when a carrying velocity of the recording material is fast, the necessity of cooling the recording material is increased much more, and thus the wider area of the cooling portion contacting the recording material is needed.

Also, a tensile force is applied to the stretching roller 35, which is arranged adjacent to the upstream side of the first stretching roller 34 in the belt moving direction, out of the rollers that are provided to stretch the first carrying belt 38, by a compression spring 40 in the direction to protrude outward. Thus, the stretching roller 35 is constructed to apply a predetermined stretching force (e.g., about 19 to 39 N (about 2 to 4 kgf)) to the first carrying belt 38.

Also, as the first carrying belt 38, an endless belt formed of a polyimide film of 75 μm thickness and having a width of 360 mm and a predetermined peripheral length, for example, may be employed. It is of course that the belt made of another material and having another size may be employed.

Also, the heat sink 39 has a heat-transferring metal plate 39a that contacts the back surface side of the first carrying belt 38. A surface 39a′ of this heat-transferring metal plate 39a contacting the first carrying belt 38 is formed like a curved shape with a predetermined radius of curvature. Also, the heat sink 39 is fitted fixedly to a frame (not shown) by which a plurality of stretching rollers 33 to 37 of the upper belt unit 31 are supported rotatably. In this case, the surface 39a′ of this heat-transferring metal plate 39a may be formed not like a curved shape but like a flat plane. This heat sink 39 absorbs a heat of the recording material 15 transmitted via the first carrying belt 38 and cools the recording material 15 while this recording material 15 is put between the first carrying belt 38 and the second carrying belt 46 and is carried. In order to enhance a cooling effect, as the case may be, the heat sink 39 may be constructed such that a heat pipe is fitted to the heat sink 39 to protrude its one end or an air is fed forcedly to the heat sink 39 itself or the protruded portion of the heat pipe by a blower and fan.

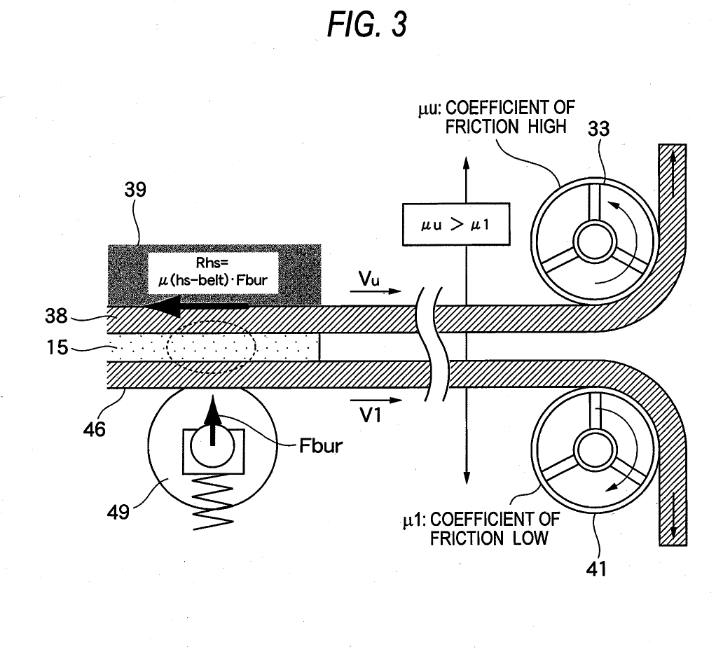

In FIG. 4 and others, for convenience, a situation that the heat-transferring metal plate 39a of the heat sink 39 contacts the driving roller 33 and the stretching roller 34 and a situation that a clearance is formed between the first carrying belt 38 and the heat-transferring metal plate 39a are illustrated. In this case, it is needless to say that the heat-transferring metal plate 39a of the heat sink 39 is separated from the driving roller 33 and the stretching roller 34, as shown in FIG. 3, and the first carrying belt 38 contacts tightly the heat-transferring metal plate 39a.

In contrast, the lower belt unit 32 has a plurality of stretching rollers 41 to 45 containing the second driving roller, the second carrying belt 46 as an endless belt member stretched between these stretching rollers 41 to 45 by a predetermined stretching force, and backup rollers 47₁ to 47₇ as a plurality (in an illustrated example, seven) of pushing materials that are provided in the inner side of the second carrying belt 46 to contact the second carrying belt 46 to the heat sink 39 with pressure. The second carrying belt 46 is preferably movable in an axial direction of the second driving roller. By this construction, the displacement of the belt can be suppressed.

These stretching rollers 41 to 45 are basically constructed similarly mutually. Each of these stretching rollers 41 to 45 is made of a metal such as aluminum, stainless steel, or the like, a rigid synthetic resin, or the like, and is formed as a round column shape or circular cylinder shape whose outer diameter is about 28 to 30 mm, for example. Also, surfaces of these stretching rollers 41 to 45 are finished to have a predetermined surface roughness as the case may be. Also, like other stretching rollers 42 to 45, the second driving roller 41 as the above second driving roller is made of a metal such as aluminum, stainless steel, or the like, a rigid synthetic resin, or the like, and is formed as a round column shape or circular cylinder shape whose outer diameter is about 28 to 30 mm. Also, a surface of the second driving roller 41 is finished to have a predetermined surface roughness. In this case, a coating layer is not provided on the surface of the second driving roller 41, as described in detail later. The second driving roller 41 is arranged adjacent to the downstream side of the area, which is caused to contact the heat sink 39 with a pressure, along the moving direction of the second carrying belt 46 such that a driving force can be applied directly to the second carrying belt 46 that is passing by the heat sink 39. Also, the second driving roller 41 is rotated/driven at a predetermined velocity (e.g., a peripheral velocity of 150 to 200 mm/sec) equal to the velocity of the first driving roller 33 by a driving source (not shown)

Also, the second carrying belt 46 is stretched like a substantially flat plane between the second driving roller 41 and the second stretching roller 42 that is arranged in the closest upstream position along the moving direction of the first carrying belt 38 via the heat sink 39. A center distance between the second driving roller 41 and the second stretching roller 42 is set slightly longer than a center distance between the first driving roller 33 and the first stretching roller 34, for example. Also, a belt surface of the second carrying belt 46 is contacting a belt surface of the first carrying belt 38 between the second driving roller 41 and the second stretching roller 42 mutually.

Also, a tensile force is applied to the stretching roller 45, which is arranged adjacent to the downstream side of the second driving roller 41 to apply a stretching force, out of the rollers that are provided to stretch the second carrying belt 46, by a compression spring 48 in the direction to protrude outward. Thus, the stretching roller 45 is constructed to apply a predetermined stretching force (e.g., about 29 to 39 N (about 3 to 4 kgf)) to the second carrying belt 46.

Also, as the second carrying belt 46, an endless belt formed of a polyimide film of 120 μm thickness and having a width of 360 mm and a predetermined peripheral length, for example, may be employed. As the second carrying belt 46, the same belt as the first carrying belt 38 may be employed, for example. But it is of course that a peripheral length, etc. may be constructed differently from those of the first carrying belt 38.

As shown in FIG. 4, in the recording material cooling device 20 constructed as above, the recording paper 15 on a surface or both surfaces of which the full-color toner image, or the like is fixed by the fixing unit 17 is introduced, and the recording paper 15 is cooled in an opposing area 49 where the first carrying belt 38 opposes to the second carrying belt 46, while carrying the recording paper 15 on which the image is fixed, between both belts. In this case, since the recording paper 15 is introduced in to the recording material cooling device 20 immediately after it passes through the fixing unit 17, the toner image fixed on the recording paper 15 is in its fused state or close to the fused state. Also, when the recording paper on both surfaces of which the toner image is fixed is carried as the recording paper 15, the first carrying belt is selected as the belt that contacts the surface, which is heated by the fixing unit, to carry the recording paper.

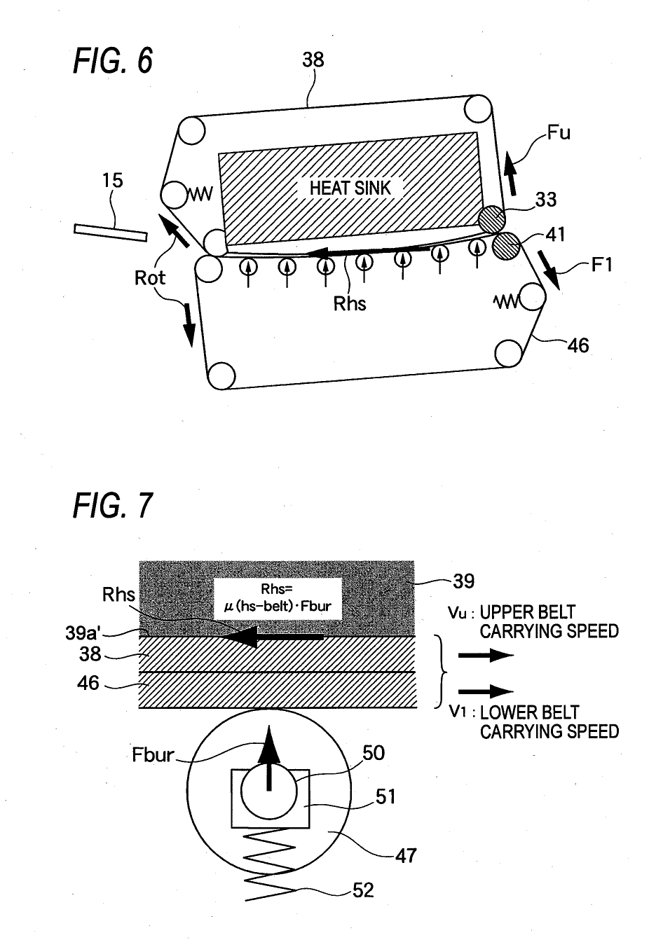

Meanwhile, as shown in FIG. 4, the first carrying belt 38 is driven by the first driving roller 33 to circulate/move at a predetermined moving velocity Vu, and the second carrying belt 46 is driven by the second driving roller 41 to circulate/move at a predetermined moving velocity V1. Here, as shown in FIG. 6, the condition under which the first and second carrying belts 38, 46 can be carried by the first and second driving rollers 33, 41 before the recording paper 15 arrives at them can be expressed as

Fu+Fl>Rhs+Rot
where Fu is a carrying force that the first driving roller 33 applies to the first carrying belt 38,
   Fl is a carrying force that the second driving roller 41 applies to the second carrying belt 46,
   Rhs is a sliding resistance that acts between the first carrying belt 38 and the heat sink 39, and
   Rot is other carrying resistance that is generated by the stretching rollers 33 to 37 for stretching the first carrying belt 38 and the stretching rollers 41 to 45 for stretching the second carrying belt 46.

Also, the condition under which the first and second carrying belts 38, 46 can be carried by the first and second driving rollers 33, 41 after the recording paper 15 arrives at them can be expressed as

Fu+Fl>Rhs+Rot+Rpa
where Rpa is a carrying resistance that is increased because of the intervention of the recording material 15.

In this case, when bearing resistances in the stretching rollers 33 to 37, 41 to 45 that stretch the first carrying belt 38 and the second carrying belt 46 respectively are reduced, other carrying resistance Rot can be reduced. Also, the carrying resistance Rpa generated due to the intervention of the recording material 15 is not so large, and can be regarded as

Rhs>>Rot+Rp

As a result, the condition under which the first and second carrying belts 38, 46 can be carried by the first and second driving rollers 33, 41 can be approximated by

Fu+Fl>Rhs.

To explain further, as shown in FIG. 4, in the recording material cooling device 20, the first carrying belt 38 and the second carrying belt 46 contact the heat sink 39 with pressure, by pushing forces of a plurality of backup rollers 47 that contact to the back surface side of the second carrying belt 46 with pressure.

The heat sink 39 is arranged in a state that it is fixed to the upper belt unit 31, while the first and second carrying belts 38, 46 are constructed to move at a predetermined moving velocity. Therefore, the sliding resistance Rhs is generated on a boundary between the first carrying belt 38 and the heat sink 39, as described above. As shown in FIG. 7, this sliding resistance Rhs (frictional force) can be expressed as

Rhs=μ(hs−belt)·Fbur

where μ(hs−belt) is a coefficient of friction between the first carrying belt 38 and the heat sink 39, and

Fbur is a pushing force of the backup rollers 47. Here, since the first carrying belt 38 contacts the surface of the heat sink 39 while moving, the coefficient of friction μ(hs−belt) between the first carrying belt 38 and the heat sink 39 means a coefficient of dynamic friction. In this case, the sliding resistance Rhs is given by taking a synthesized sliding resistance of a plurality of backup rollers 47 into consideration.

When a pushing force Fbur of the backup rollers 47 is not so large, the sliding resistance Rhs does not take so a large value, as shown in FIG. 7, and thus a velocity component of the moving velocity Vu of the first carrying belt 38, which is lowered by the sliding resistance Rhs, is small. Therefore, when the sliding resistance Rhs generated on the boundary 39a′ between the first carrying belt 38 and the heat sink 39 is small, a reduction in the velocity of the first carrying belt 38 is small. As a result, when the first carrying belt 38 contacts the second carrying belt 46 directly or via the recording material 15, this first carrying belt 38 is moved at the velocity Vu (≈V1) that is substantially equal to a moving velocity V1 of the second carrying belt 46.

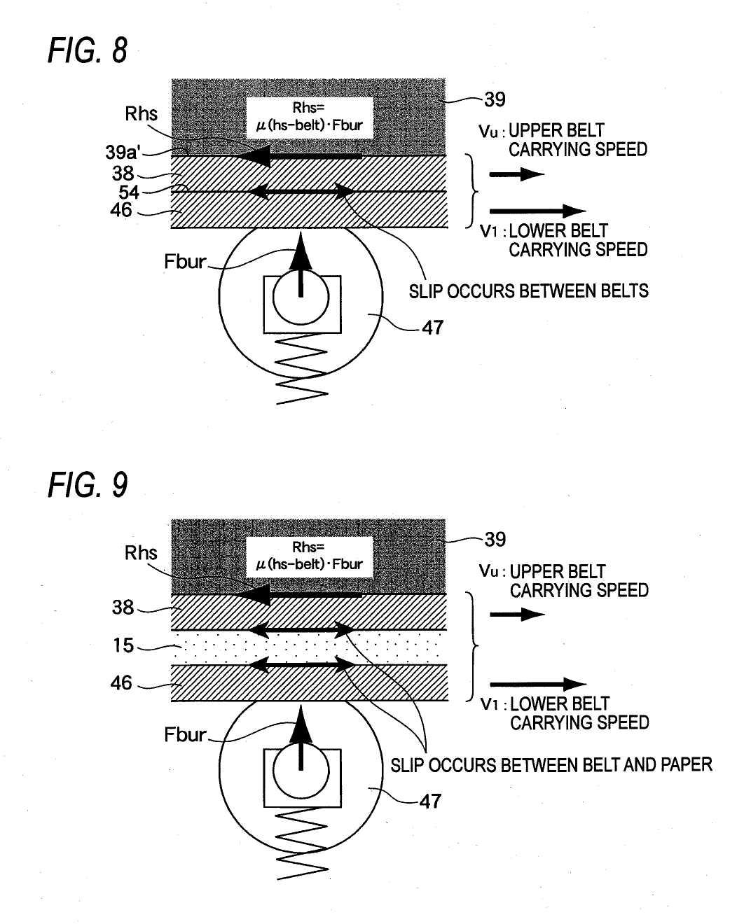

In contrast, in order to increase a cooling effect of the heat sink 39, a bearing having a large energizing force as a compression spring 52, which energizes the second carrying belt 46 toward the heat sink 39 side, is employed as a bearing portion 51 that supports rotatably a rotating shaft 50 of the backup rollers 47. Hence, when the pushing force Fbur of the backup rollers 47 is increased, the sliding resistance Rhs takes a large value, as shown in FIG. 8, and the moving velocity Vu of the first carrying belt 38 is largely lowered. Therefore, when the sliding resistance Rhs generated on the boundary 39a′ between the first carrying belt 38 and the heat sink 39 takes a large value, a reduction of the velocity generated in the first carrying belt 38 becomes large. As a result, it is feared that a slip is caused between the first carrying belt 38 and the second carrying belt 46 by a velocity deference (=V1−Vu) between the first carrying belt 38 and the second carrying belt 46 and a contact surface 54 is damaged and that, as shown in FIG. 8, the toner image fixed onto the recording material is disturbed by a velocity deference generated between the recording material and the first carrying belt 38 or the second carrying belt 46.

Here, when the recording material 15 is interposed between the first carrying belt 38 and the second carrying belt 46, a slip is caused between the recording material 15 and the first carrying belt 38 or between the recording material 15 and the second carrying belt 46, as shown in FIG. 9. Whether or not a slip is caused either between the recording material 15 and the first carrying belt 38 or between the recording material 15 and the second carrying belt 46 is decided depending upon which one of magnitudes of a frictional force between the recording material 15 and the first carrying belt 38 and a frictional force between the recording material 15 and the second carrying belt 46 is larger.

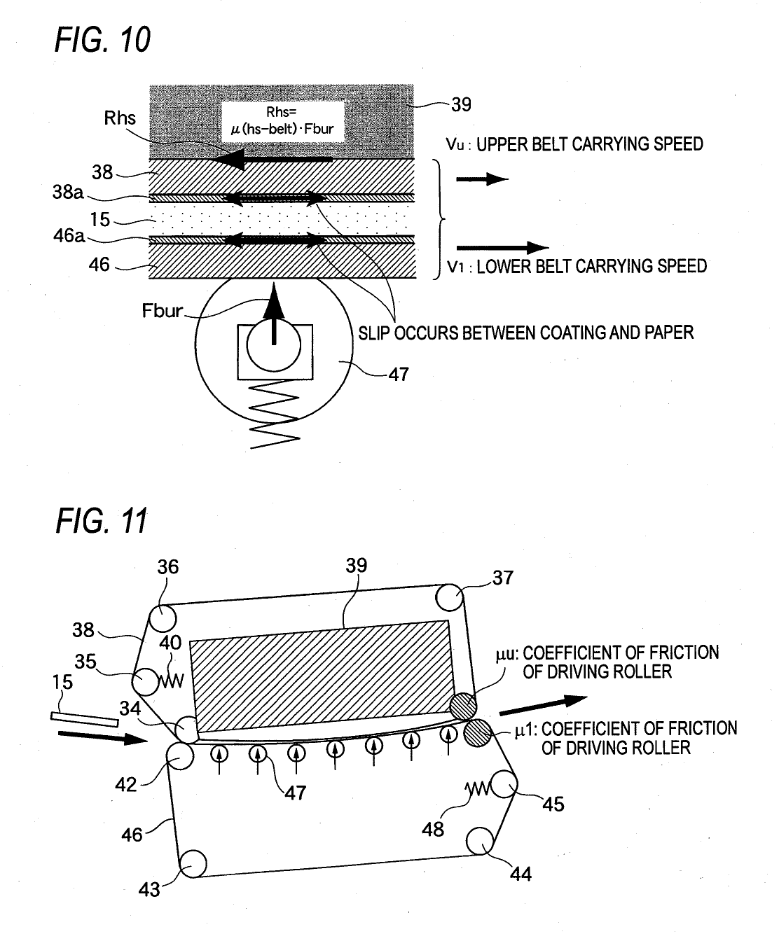

Also, as shown in FIG. 10, when the coating layers 38a, 46a are provided on the surfaces of the first carrying belt 38 and the second carrying belt 46 contacting the recording material 15 respectively, it is feared that a slip is caused between the coating layers 38a, 46a and the recording material 15 and the coating layers 38a, 46a of the first carrying belt 38 and the second carrying belt 46 and the image on the recording material 15 are damaged.

For this reason, in the present exemplary embodiment, a velocity deference between any one of the first carrying belt 38 and the second carrying belt 46 and the driving roller for driving the concerned carrying belt is set larger in absolute value than velocity deferences between the recording material and the first carrying belt 38 and the second carrying belt 46.

More particularly, in the recording material cooling device 20 according to this embodiment, a velocity difference (absolute value) larger than the velocity deference ΔV (=V1−Vu) is generated between either of the first carrying belt 38 and the second carrying belt 46, in this case, the second carrying belt 46 whose moving velocity is high, and the second driving roller 41 for driving the second carrying belt 46. This is because, even though the sliding resistance Rhs acting between the first carrying belt 38 and the heat sink 39 becomes excessively large and then the moving velocity Vu of the first carrying belt 38 is largely lowered, an occurrence of such a situation that the velocity deference ΔV (=V1−Vu) is generated between either of the first carrying belt 38 and the second carrying belt 46 should be prevented.

Here, when the velocity deference larger than the velocity deference ΔV (=V1−Vu) is generated between the second carrying belt 46 whose moving velocity is high and the second driving roller 41, the moving velocity V1 of the second carrying belt 46 is lowered and as a result the velocity deference ΔV (=V1−Vu) is reduced.

At this time, it is desirable that the velocity deference ΔV (=V1−Vu) should not be generated between the first carrying belt 38 and the second carrying belt 46. In this case, if this velocity deference ΔV is small to some extent, the damage caused in the first and second carrying belts 38, 46 and the recording material 15 can be lessened and an effect can be achieved. Further, it is more desirable that the velocity deference ΔV (=V1−Vu) generated between the first carrying belt 38 and the second carrying belt 46 should be eliminated.

To explain further more, as shown in FIG. 3, the case where the recording material 15 is interposed between both carrying belts 38, 46 is considered. Then, a frictional force generated between the second carrying belt 46 whose moving velocity is high and the second driving roller 41 for driving this second carrying belt 46 is set smaller than a frictional force generated between the recording material 15 and the first and second carrying belts 38, 46.

In this exemplary embodiment, a coefficient of static friction μl between the surface of the second driving roller 41 and the second carrying belt 46 is set small by not providing the coating layer on the surface of the second driving roller 41. Thus, a static frictional force generated between the second carrying belt 46 and the second driving roller 41 is reduced smaller than that generated between the first carrying belt 38 and the first driving roller 33. Therefore, a frictional force generated between the second carrying belt 46 and the second driving roller 41 is made smaller than a frictional force generated between the recording material 15 and the first and second carrying belts 38, 46.

Therefore, as shown in FIG. 3, a frictional force generated between the second carrying belt 46 whose moving velocity is high and the second driving roller 41 for driving the second carrying belt 46 is set smaller than a frictional force generated between the recording material 15 and the first and second carrying belts 38, 46. As a result, a slip is generated between the second carrying belt 46 and the second driving roller 41 for driving the second carrying belt 46, and thus the relative velocity deference ΔV between the first carrying belt 38 and the second carrying belt 46 can be suppressed.

As described above, the first driving roller 33 for driving the first carrying belt 38 is constructed by coating the coating layer 33a made of polyurethane, cellular silicon rubber, or the like on the surface of the stainless roller up to a predetermined thickness of about 2.5 mm. And, the outer diameter of the first driving roller 33 is set to have the same value as those of other stretching rollers 34 to 37. Therefore, as shown in FIG. 11, a coefficient of static friction μu between the surface of the first driving roller 33 and the first carrying belt 38 is set larger than a coefficient of static friction μl between the surface of the second driving roller 41 and the second carrying belt 46.

Then, the inventors of the present invention test—manufactured only the upper belt unit 31 in which the first carrying belt 38 is stretched without the heat sink 39 and a different load can be applied to one stretching roller except the first driving roller 33 in FIG. 4, and then tried experiments to measure a slip ratio generated between the first carrying belt 38 and the first driving roller 33 while changing a stretching force of the first carrying belt 38.

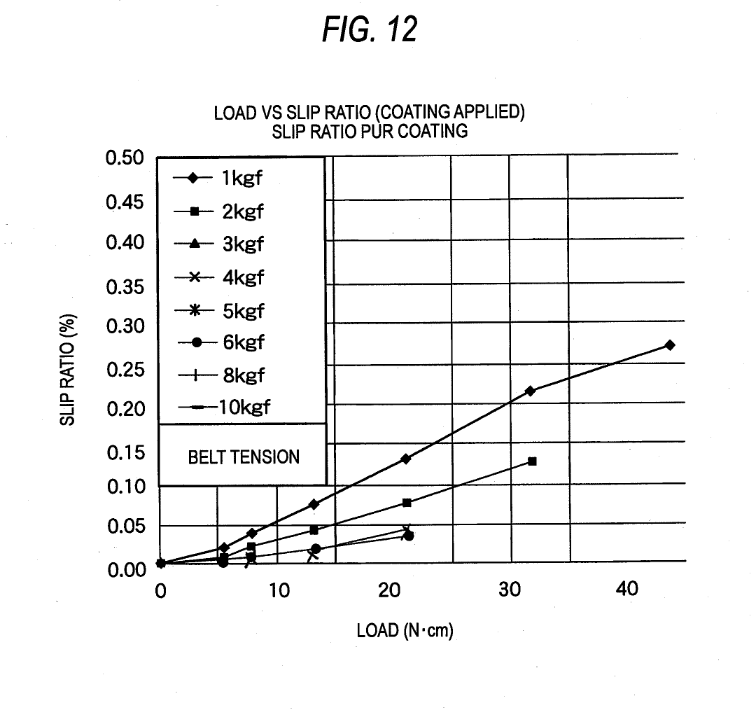

FIG. 12 shows results of the above experiments.

As apparent from FIG. 12, it is understood that, if a stretching force of the first carrying belt 38 is in excess of 19.6 N (2 kgf), a slip ratio generated between the first carrying belt 38 and the first driving roller 33 can be suppressed smaller than 0.15, and thus the slip is seldom generated. Also, it is understood that, if a stretching force of the first carrying belt 38 is 39 N (4 kgf), a slip ratio generated between the first carrying belt 38 and the first driving roller 33 is less than 0.05 when a load is 20 N·cm, and thus the slip is seldom generated.

In contrast, as described above, the stainless roller itself whose surface roughness is finished in a predetermined state is employed as the second driving roller 41 for driving the second carrying belt 46, the coating layer is not provided, and the outer diameter of the second driving roller 41 is set to the same values of other stretching rollers 42 to 45. Therefore, the coefficient of static friction μl between the second driving roller 41 and the second carrying belt 46 is set smaller than the coefficient of static friction between the first driving roller 33 and the first carrying belt 38.

Then, the inventors of the present invention test—manufactured only the lower belt unit 32 in which the second carrying belt 46 is stretched without the backup rollers 47 and a different load can be applied to one stretching roller except the second driving roller 41 in FIG. 4, and then tried experiments to measure a slip ratio generated between the second carrying belt 46 and the second driving roller 41 while changing a stretching force of the second carrying belt 46.

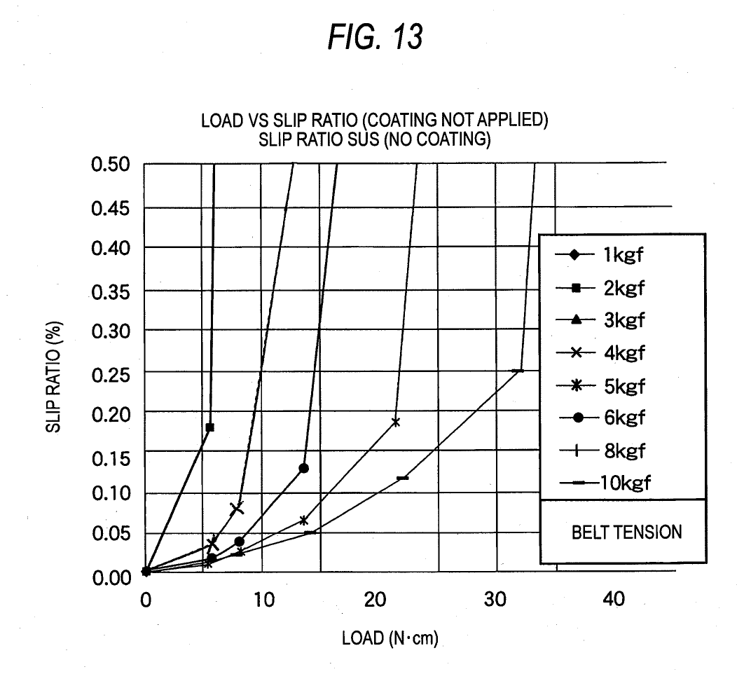

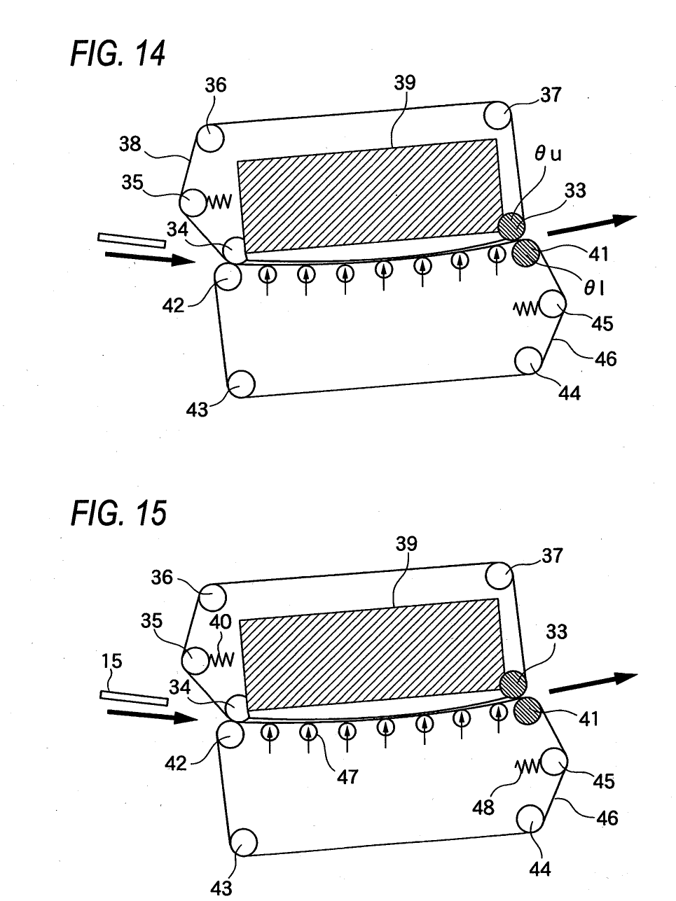

FIG. 13 shows results of the above experiments.

As apparent from FIG. 13, it is understood that, if a load is increased to about 20 N·cm, a slip ratio generated between the second carrying belt 46 and the second driving roller 41 is increased suddenly to 0.50 or more even though a stretching force of the second carrying belt 46 have a high value such as 78.4 N or 98.1 N (8 kgf or 10 kgf), and thus the slip is generated in most cases.

Therefore, a frictional force acting between the second carrying belt 46 and the second driving roller 41 can be adjusted by changing the surface condition of the second driving roller 41 for driving the second carrying belt 46.

At that time, in the recording material cooling device 20 shown in FIG. 4, a frictional force between the first driving roller 33 and the first carrying belt 38 is set large. Thus, a slip between the first driving roller 33 and the first carrying belt 38 can be suppressed.

Also, if the material and the surface state of the first carrying belt 38 and the heat sink 39, the moving velocity of the first carrying belt 38, and the pressure applied by the backup rollers 47 are decided, the carrying resistance Rpa acting the first carrying belt 38 and the heat sink 39 takes the predetermined value Rhs=μ(hs−belt)·Fbur.

For this reason, a value of the moving velocity Vu of the first carrying belt 38 reduced by the sliding resistance Rhs acting between the first carrying belt 38 and the heat sink 39 takes the already-known value. It can be seen that to what extent the coefficient of static friction μl between the surface of the second driving roller 41 and the second carrying belt 46 should be set such that the relative velocity deference ΔV generated between the first carrying belt 38 and the second carrying belt 46 can be suppressed.

In other words, in the full color printer to which the recording material cooling device according to this embodiment is applied, as shown in FIG. 2, the toner images in respective colors of yellow (Y), magenta (M), cyan (C), and black (K) are formed on photosensitive drum 3 in the image forming portions 2Y, 2M, 2C, 2K in respective colors of yellow (Y), magenta (M), cyan (C), and black (K) Then, these toner images in respective colors are transferred in multiple colors onto the intermediate transfer belt 8, and then secondarily transferred collectively from the intermediate transfer belt 8 to the recording paper 15.

Then, the unfixed toner image is fixed to the recording paper 15 by the fixing unit, the recording paper 15 is cooled by exhausting a heat while such paper is carried by the recording material cooling device 20, and the recording paper 15 is discharged on the paper receiving tray 21. Thus, the printing process is ended.

At that time, in the recording material cooling device 20, the first carrying belt 38 and the second carrying belt 46 are driven by the first and second driving rollers 33, 41 to circulate/move at the predetermined velocity, as shown in FIG. 4, and the recording paper 15 that is subject to the fixing process by a heat and a pressure applied from the fixing unit 17 is introduced a space between the first carrying belt 38 and the second carrying belt 46, as shown in FIG. 3.

Then, while the recording paper 15 is put between the first carrying belt 38 and the second carrying belt 46 and carried, a heat is taken from the recording paper 15 by the first carrying belt 38 and the second carrying belt 46. Then, a heat transferred to the first carrying belt 38 is radiated by the heat sink 39.

By the way, the heat sink 39 comes in contact with the back surface side of the first carrying belt 38. When the first carrying belt 38 and the second carrying belt 46 are driven by the first and second driving rollers 33, 41 to circulate/move at the predetermined velocity, the velocity of the first carrying belt 38 is lowered relatively to the second carrying belt 46 due to the sliding resistance to the heat sink 39.

At that time, in this embodiment, as shown in FIG. 3, the coefficient of static friction μl of the second driving roller 41 to the second carrying belt 46 is set smaller than that of the first driving roller 33, and also a frictional force generated between the second driving roller 41 and the second carrying belt 46 is set smaller than a frictional force generated between the recording material 15 and the first and second carrying belts 38, 46. Therefore, a slip is generated between the second driving roller 41 and the second carrying belt 46, so that the relative velocity deference ΔV generated between the first carrying belt 38 and the second carrying belt 46 is suppressed, and an occurrence of a slip between the recording material 15 and the first and second carrying belts 38, 46 is suppressed.

### Embodiment 3

FIG. 14 shows Embodiment 3 of the present invention. Explanation will be made by affixing the same reference symbols to the same portions as those in Embodiment 1. In this Embodiment 3, a wrapping angle at which the second belt-like member is wrapped on the second driving roller is set smaller than a wrapping angle at which the first belt-like member is wrapped on the first driving roller.

In other words, in this Embodiment 3, as shown in FIG. 14, the stretching roller 45 positioned on the downstream side of the second driving roller 41 is arranged to protrude on the outside that intersects orthogonally with the moving direction of the second carrying belt 46, and a wrapping angle at which the second carrying belt 46 is wrapped on the second driving roller 41 is set smaller than 90 degree.

In contrast, as shown in FIG. 14, the first driving roller 33 is set such that the stretching roller 37 positioned on the downstream side is arranged on the inner side of the moving direction of the first carrying belt 38 and a wrapping angle at which the first carrying belt 38 is wrapped on the first driving roller 33 is set larger than 90 degree. As a result, a wrapping angle at which the second carrying belt 46 is wrapped on the second driving roller 41 is set smaller than a wrapping angle at which the first carrying belt 38 is wrapped on the first driving roller 33.

As a result, above Embodiment 2, as shown FIG. 14, a frictional force acting between the first driving roller 33 and the first carrying belt 38 is set larger than a frictional force acting between the second driving roller 41 and the second carrying belt 46. Therefore, a slip is generated between the second driving roller 41 and the second carrying belt 46, so that the relative velocity deference ΔV generated between the first carrying belt 38 and the second carrying belt 46 is suppressed and a slip is hardly generated between the recording material 15 and the first and second carrying belts 38, 46.

In this case, the roller same as the second driving roller 41 is used as the first driving roller 33.

Since other configurations and operations are similar to those in above Embodiment 1, their explanation will be omitted.

### Embodiment 4

FIG. 15 shows Embodiment 4 of the present invention. Explanation will be made by affixing the same reference symbols to the same portions as those in Embodiment 1. In this Embodiment 4, a stretching force of the second belt-like member is set smaller than a stretching force of the first belt-like member.

In other words, in this Embodiment 4, as shown in FIG. 15, a spring constant of the compression spring 48 that applies a stretching force to the second carrying belt 46 is set smaller than a spring constant of the compression spring 40 that applies a stretching force to the first carrying belt 38. As a result, a stretching force of the second carrying belt 46 is set smaller than a stretching force of the first carrying belt 38.

Also, in this Embodiment 4, as apparent from the experimental results shown in FIG. 13, a slip is generated between the second carrying belt 46 whose stretching force is smaller and the driving roller more easily than between the first carrying belt 38 whose stretching force is relatively large and the driving roller. Therefore, a slip is generated between the second driving roller 41 and the second carrying belt 46, so that the relative velocity deference ΔV generated between the first carrying belt 38 and the second carrying belt 46 is suppressed and a slip is hardly generated between the recording material 15 and the first and second carrying belts 38, 46.

In this case, the roller same as the second driving roller 41 is used as the first driving roller 33.

Since other configurations and operations are similar to those in above Embodiment 1, their explanation will be omitted.

### Embodiment 5

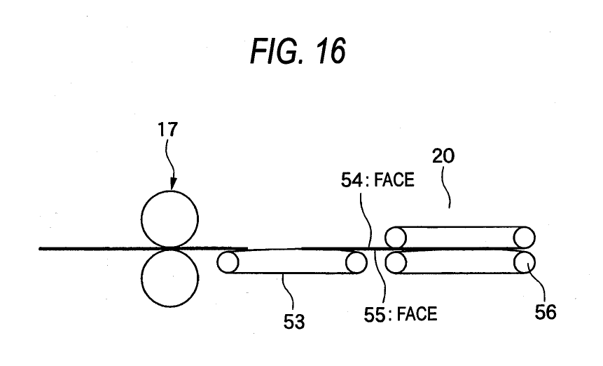

FIG. 16 shows Embodiment 5 of the present invention. Explanation will be made by affixing the same reference symbols to the same portions as those in Embodiment 1. In this Embodiment 5, a belt carrying member 53 is arranged between the fixing unit and the recording material cooling device.

Here, the recording material 15 is passed through the fixing unit in a state that the toner image is borne on both surfaces of the recording material, an amount of heat is given to the 54 face side of the recording material more largely than the 55 face side by the fixing unit, and the fused state of the toner image on the 54 face side is advanced rather than the toner image on the 55 face side. When something contacts a part of the toner image that is in the fused state, the damage is caused such that a temperature is lowered at that portion, an unevenness occurs, the toner image is disturbed, or the like.

The recording material 15 fed from the fixing unit 17 is carried in a state that the 55 face side of the recording material is contacting the belt carrying member 53, and then is carried to the recording material cooling device 20. In this event, the surface of the recording material 15, which is ready to be damaged, does not touch with anything until such surface comes into contact with the first belt after the recording material is sent out from the fixing unit 17.

Also, a torque limiter 56 may be employed in the driving roller that drives the second belt. In this case, the roller itself for driving the belt may be classified into the driving shaft and the driving roller driven by the driving shaft, and a slip may be generated between the driving shaft and the driving roller. But a cost of the torque limiter 56 is needed in this case.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A sheet carrying unit, comprising:
a first belt stretched by a plurality of rollers, the first belt carrying a sheet while putting the sheet on a surface of the first belt;
a first driving roller that drives the first belt;
a second belt stretched by a plurality of rollers, the second belt carrying the sheet while holding the sheet together with the first belt; and
a second driving roller that drives the second belt;
wherein a frictional force generated between the second driving roller and the second belt is set smaller than a frictional force generated between the first belt and the first driving roller, a frictional force generated between the first belt and the sheet, and a frictional force generated between the second belt and the sheet, respectively.

2. The sheet carrying unit according to claim 1,
wherein a coefficient of static friction between the second driving roller and the second belt is set smaller than a coefficient of static friction between the first driving roller and the first belt.

3. The sheet carrying unit according to claim 1,
wherein a wrapping angle of the second belt on the second driving roller is set smaller than a wrapping angle of the first belt on the first driving roller.

4. The sheet carrying unit according to claim 1,
wherein a stretching force of the second belt is set smaller than a stretching force of the first belt.

5. The sheet carrying unit according to claim 1,
wherein the second belt is movable in an axial direction of the second driving roller.

6. A sheet cooling device, comprising:
a first belt that contacts a toner image formed on a sheet and carries the sheet;
a cooling unit that cools the toner image via the first belt, the cooling unit being positioned on an inner peripheral surface of the first belt;
a first driving roller that drives the first belt;
a second belt stretched by a plurality of rollers, the second belt carrying the sheet while holding the sheet together with the first belt; and
a second driving roller that drives the second belt;
wherein a frictional force generated between the second driving roller and the second belt is set smaller than a frictional force generated between the first belt and the first driving roller, a frictional force generated between the first belt and the sheet, and a frictional force generated between the second belt and the sheet, respectively.

7. The sheet cooling device according to claim 6,
wherein a coefficient of static friction between the second driving roller and the second belt is set smaller than a coefficient of static friction between the first driving roller and the first belt.

8. The sheet cooling device according to claim 6,
wherein a wrapping angle of the second belt on the second driving roller is set smaller than a wrapping angle of the first belt on the first driving roller.

9. The sheet cooling device according to claim 6,
wherein a stretching force of the second belt is set smaller than a stretching force of the first belt.

10. The sheet cooling device according to claim 6,
wherein the second belt is movable in an axial direction of the second driving roller.

11. The sheet cooling device according to claim 6,
wherein the first driving roller is positioned on a downstream side of the cooling unit in a sheet carrying direction.

12. The sheet cooling device according to claim 6, further comprising:
a backup roller that pushes the sheet against the cooling unit, the backup roller being positioned on an inner peripheral surface of the second belt.

13. An image forming apparatus, comprising:
an image forming portion that forms a toner image on a sheet;
a fixing unit that fixes the toner image by applying a heat to the sheet;
a first belt that contacts the toner image formed on the sheet and carries the sheet;
a cooling unit that cools the toner image via the first belt, the cooling unit being positioned on an inner peripheral surface of the first belt;
a first driving roller that drives the first belt;
a second belt stretched by a plurality of rollers, the second belt carrying the sheet while putting the sheet on a surface of the second belt; and
a second driving roller that drives the second belt;
wherein a frictional force generated between the second driving roller and the second belt is set smaller than a frictional force generated between the first belt and the first driving roller, a frictional force generated between the first belt and the sheet, and a frictional force generated between the second belt and the sheet, respectively.

14. The image forming apparatus according to claim 13,
wherein a coefficient of static friction between the second driving roller and the second belt is set smaller than a coefficient of static friction between the first driving roller and the first belt.

15. The image forming apparatus according to claim 13,
wherein a wrapping angle of the second belt on the second driving roller is set smaller than a wrapping angle of the first belt on the first driving roller.

16. The image forming apparatus according to claim 13,
wherein a stretching force of the second belt is set smaller than a stretching force of the first belt.

17. The image forming apparatus according to claim 13,
wherein the second belt is movable in an axial direction of the second driving roller.

18. The image forming apparatus according to claim 13,
wherein the first driving roller is positioned on a downstream side of the cooling unit in a sheet carrying direction.

19. The image forming apparatus according to claim 13, further comprising:
a backup roller that pushes the sheet against the cooling unit, the backup roller being positioned on an inner peripheral surface of the second belt.

20. The image forming apparatus according to claim 13,
wherein a toner image face of the sheet that passed through the fixing unit first contacts the first belt.
